(19) United States
(12) Patent Application Publication
(10) Pub. No.: US 2024/0197103 A1
(43) Pub. Date: Jun. 20, 2024

(54) ELECTRIC PRESSURE COOKER WITH BOTH PRESSURE COOKING AND AIR FRYING COOKING AND HEATING METHOD THEREOF

(71) Applicant: GUANGDONG SHUNDE OUNING TECHNOLOGY ELECTRICAL APPLIANCE CO., LTD., Guangdong (CN)

(72) Inventors: Zhenxiong HUANG, Guangdong (CN); Liukui XING, Guangdong (CN)

(73) Assignee: GUANGDONG SHUNDE OUNING TECHNOLOGY ELECTRICAL APPLIANCE CO., LTD., Guangdong (CN)

(21) Appl. No.: 17/908,536

(22) PCT Filed: May 31, 2022
(86) PCT No.: PCT/CN2022/096365

§ 371 Date: Sep. 1, 2022

(30) Foreign Application Priority Data
May 17, 2022 (CN) 202210536959.1

(51) Int. Cl. A47J 27/086; A47J 37/06

(52) U.S. Cl. CPC A47J 27/086; A47J 37/0641

(57) ABSTRACT

An electric pressure cooker with both pressure cooking and air frying cooking comprises a cooker body and a cooker cover that is capable of covered on the cooker body; and further comprises a heat preservation housing provided in the cooker body, an inner pot that is capable of being placed in the heat preservation housing for pressure cooking or a frying basket for air frying cooking, a reflex housing disposed outside the heat preservation housing and a heating assembly provided in the heat preservation housing; the reflex housing is communicated with the heat preservation housing; the cooker body is further provided with a drive assembly that is capable of making the hot air circulate in the heat preservation housing and the reflex housing.

### TECHNICAL FIELD

The present invention relates to the technical field of electric pressure cookers, and more particularly, to an electric pressure cooker with both pressure cooking and air frying cooking and a heating method thereof.

### BACKGROUND

At present, the pressure air fryers on the market have the functions and characteristics of electric pressure cookers and air fryers, that is, they can be used for both electric pressure cooking and hot air baking. The pressure air fryers can easily realize functions of high and low pressure stewing, boiling, braising, baking, air frying, dehydration and the like, which are very popular with users. Among them, pressure air fryers of some models have two covers: when pressure cooking is required, a pressure cooker cover is used to seal the inner pot; when the air fryer function is required, the pressure cooker cover is removed and an air fryer cover is used. There are also pressure air fryers of some models that integrate the pressure cooker cover and the air fryer cover into a multi-function cover, which can be switched between pressure cooking and air frying functions with a flip of a button, and thus are more convenient for using.

Although the above technology seems to be very convenient for using, there are still many shortcomings, mainly as follows: 1. most of the products adopt a dual heat source heating structure, that is to say, when the pressure cooking function is selected, the product will activate a corresponding heating plate; when the air fryer function is selected, another heating tube will be activated; 2. two cooker covers are required: when the pressure cooking function is selected, the pressure cooker cover must be used; when the air fryer function is selected, the air fryer cover must be used. The above deficiencies lead to complex product structure and high cost.

There are also pressure air fryers with only one heat source on the market. They only have one heating plate, while the heat dissipation area of the heating plate is enlarged such that it has a certain air heating function. However, due to the limited structure and the low heat resistance of the heating plate, its air frying performance cannot meet the requirements of the product standard.

For example, a multifunctional air fryer is disclosed in the prior art, which includes an air fryer body and an electric pressure cooker cover. The air fryer body includes an outer shell, an inner pot provided in the outer shell, and an air fryer cover provided on the outer shell. The electric pressure cooker cover can be matched with the inner pot, and the outer shell is provided with an operation panel and a control circuit. The operation panel is electrically connected to the control circuit. The air fryer cover is covered on and engaged with the inner pot to give a trigger signal to the control circuit, and the control circuit works in an air fryer mode. The electric pressure cooker cover is covered on and engaged with the inner pot to give another trigger information to the control circuit, and the control circuit works in the electric pressure cooker mode. Although the multifunctional air fryer is an integrated product combined by air fryer and pressure cooker, which has only one operation panel and simplifies the functions of the multifunctional air fryer, the multifunctional air fryer is provided with two covers, which is complicated in structure, prone to failure, and high in cost. During use, the control circuit needs to switch the working modes, which is very inconvenient for using.

### SUMMARY OF INVENTION

To overcome the technical problems that the product integrating electric pressure cooker and air fryer is complicated in structure, high in cost and inconvenient in use in the above-mentioned prior art, the present invention provides an electric pressure cooker having both pressure cooking and air frying cooking and a heating method thereof, wherein the electric pressure cooker has a single cooker cover, a single heat source, a simple overall structure, a convenience of use and a good cooking performance.

In order to solve the above-mentioned technical problems, the technical solution adopted in the present invention is as follows: an electric pressure cooker with both pressure cooking and air frying cooking comprises a cooker body and a cooker cover that is capable of being covered on and engaged with the cooker body; and the electric pressure cooker further comprises a heat preservation housing in the cooker body, an inner pot that is capable of being placed in the heat preservation housing and used for pressure cooking or a frying basket that is capable of being placed in the heat preservation housing and used for air frying cooking, a reflex housing disposed outside the heat preservation housing and a heating assembly disposed in the heat preservation housing; the reflex housing is communicated with the heat preservation housing; the cooker body is further provided with a drive assembly that is capable of making the hot air circularly flow in the heat preservation housing and the reflex housing.

When the present invention is used, the inner pot or frying basket is placed in the heat preservation housing of the cooker body (i.e., the inner pot only needs to be placed in the heat preservation housing when the present invention is required to be used as a pressure cooker, and the frying basket only needs to be placed in the heat preservation housing with the inner pot being taken out when the present invention is required to be used as an air fryer), and the cooker cover is placed on and engaged with the cooker body, the heating assembly generates heat to heat the air in the heat preservation housing, and the drive assembly can make the hot air circularly flow the heat preservation housing and the reflex housing, and the air is heated repeatedly in the process of circular flowing, which is conducive to heating the food. The overall structure of the present invention is simple to be configured. Compared with the existing product integrating electric pressure cooker and air fryer, only one cooker cover and one set of heating assembly are provided in the present invention. Only the inner pot or frying basket needs to be replaced when different cooking modes need to be switched. The electric pressure cooker of the present invention is convenient and handy, has a production cost, and is also very convenient for using. At the same time, in the process of cooking food, the hot air flows circularly, and thus the electric pressure cooker of the present invention can effectively heat and cook the food and can meet the requirements of product standards, regardless of the cooking performance of the pressure cooker and the air frying performance.

Preferably, the heat preservation housing is communicated with the reflex housing via a plurality of first through holes; the plurality of first through holes are respectively provided at a bottom portion and a side portion of the heat preservation housing.

Preferably, the frying basket comprises a basket body, an enclosure ring for supporting the basket body, and a tray with ventilation holes which is provided in the basket body; a side wall of the basket body is provided with a plurality of second through holes; a bottom portion of the basket body is provided with a third through hole; the basket body is provided with an oil baffle for blocking oil and water generated during a food cooking process; the oil baffle is located above the third through hole; an anti-fume sieve for filtering the oil fume from the basket body entering the heat preservation housing is further provided in the basket body, the anti-fume sieve is located between the oil baffle and the third through hole.

Preferably, the heat preservation housing is connected with a pressure control assembly for controlling a pressure in the inner pot during a cooking process.

Preferably, the pressure control assembly comprises a pressure ring, a plurality of elastic bodies, a displacement sensor for detecting a position change of the heat preservation housing and a controller; the pressure ring is fixedly connected to the heat preservation housing; one end of the plurality of elastic bodies is connected to the pressure ring, and another end of the plurality of elastic bodies is connected to the cooker body; a signal input end of the controller is communicatively connected to the displacement sensor, and a signal output end of the controller is communicatively connected to the heating assembly.

Preferably, the displacement sensor is fixedly provided on the cooker body; the displacement sensor is a displacement detection switch; a trigger push rod of the displacement detection switch is connected to the heat preservation housing, or is connected to the pressure ring; or the trigger push rod of the displacement detection switch is connected to the reflex housing when the reflex housing is fixedly connected to the heat preservation housing.

Preferably, the cooker cover comprises a cooker cover body and a sealing ring. The sealing ring is provided on an inner side of the cooker cover body. An upper edge of the inner pot is provided with an outwardly extending pot rim. When the inner pot is placed in the heat preservation housing and when the cooker cover covered on and engaged with the cooker body, an upper surface of the pot rim abuts against the sealing ring, and a lower surface of the pot rim abuts against the pressure ring.

Preferably, the cooker body comprises a shell body and a cylindrical body that is capable of being interlocked with the cooker cover. The cylindrical body is connected to the shell body. A lower edge of the cylindrical body is bent inward to form a step. The plurality of elastic bodies is provided between the pressure ring and the step.

Preferably, the cooker cover further comprises a reflective inner cover. The reflective inner cover is provided on the inner side of the cooker cover body.

Preferably, the drive assembly comprises a first fan that is rotatable and a motor for driving a movement of the first fan. An output shaft of the motor is connected to the first fan. The first fan is provided in the reflex housing. The motor is provided d at an outer side of the reflex housing. The motor is connected to the cooker body or connected to the reflex housing via a motor bracket.

Preferably, the heating assembly comprises a heat-conducting plate for supporting the inner pot or the frying basket and a first heater provided on the heat-conducting plate. The heat-conducting plate and the first heater are both provided in the heat preservation housing.

Preferably, the heating assembly comprises a heat-conducting plate for supporting the inner pot or the frying basket and a second heater located below the heat-conducting plate. The heat-conducting plate is provided in the heat preservation housing. The heat-conducting plate is provided with several heat dissipation grooves.

Preferably, the heating assembly comprises a heat-conducting plate for supporting the inner pot or the frying basket and a first heater located below the heat-conducting plate. The heat-conducting plate and the first heater are both provided in the heat preservation housing. The heating assembly further comprises a second heater provided on the heat-conducting plate.

Preferably, a temperature sensor for detecting a temperature of the heat-conducting plate is provided in the heat-conducting plate.

A heating method for the electric pressure cooker with both pressure cooking and air frying cooking as mentioned above, comprising:
when an inner pot is placed in a heat preservation housing and used as a pressure cooker, forming a space A by a space between the inner pot and the heat preservation housing, and forming a space B by a space between the heat preservation housing and a reflex housing, and a heating assembly located in the heat preservation housing being capable of simultaneously heating air in the space A and an bottom of the inner pot, and under an driving action of a drive assembly, air heating in the space A forming a circulating flow between the space A and the space B to heat food in the inner pot;
when the inner pot is removed and a frying basket is placed in the heat preservation housing and used as an air fryer, forming a space C between the frying basket and an bottom of the heat preservation housing, forming a space D between the heat preservation housing and the reflex housing, forming a space E by the frying basket and a side wall of the heat preservation housing, and forming a space F by a space in the frying basket, the heat preservation housing being capable of heating air in the space C first, under the driving action of the drive assembly, air heating in the space C being capable of passing through the space D, the space E and the space F in sequence, and then flowing into the space C to form a circulating flow to heat food in the frying basket.

Compared with the prior art, the beneficial effects of the present invention are as follows:

1) The present invention has both the function of the pressure cooker and the air fryer. Compared with the existing integrated product combined by air fryer and pressure cooker, only one cooker cover and one set of heating assembly are provided in present invention. Only the inner pot or frying basket needs to be replaced when different cooking modes need to be switched. The overall structure of the present invention is simple to be configured. The electric pressure cooker of the present invention is convenient and handy. The overall structure of the electric pressure cooker of the present invention is simple to be configured. The electric pressure cooker of the present invention has a low production cost, and is also very convenient for using.

2) In the process of cooking food, the hot air flows circularly, the electric pressure cooker of the present invention can effectively heat and cook the food, and can meet the requirements of product standards, regardless of the cooking performance of the pressure cooker and the air frying performance.

### BRIEF DESCRIPTION OF DRAWINGS

FIG. 1 is a schematic structural view of an electric pressure cooker with both pressure cooking and air frying cooking in embodiment 1 of the present invention;

FIG. 2 is an enlarged view of part A in FIG. 1;

FIG. 3 is a schematic structural view of the present invention when used as a pressure cooker (wherein the direction of the arrow is the direction of hot air circulation);

FIG. 4 is an enlarged view of part B in FIG. 3;

FIG. 5 is a schematic structural view of the present invention when used as an air fryer (wherein the direction of the arrow is the direction of hot air circulation);

FIG. 6 is a schematic structural view of an electric pressure cooker with both pressure cooking and air frying cooking in embodiment 2 of the present invention;

FIG. 7 is a schematic structural view of an electric pressure cooker with both pressure cooking and air frying cooking in embodiment 3 of the present invention;

FIG. 8 is a schematic structural view of an electric pressure cooker with both pressure cooking and air frying cooking in embodiment 4 of the present invention;

FIG. 9 is a schematic structural view of an electric pressure cooker with both pressure cooking and air frying cooking in embodiment 5 of the present invention;

FIG. 10 is a schematic structural view of an electric pressure cooker with both pressure cooking and air frying cooking in embodiment 6 of the present invention.

In the drawings: 1—cooker body; 11—shell body; 111—opening; 12—cylindrical body; 121—buckle teeth; 122—step; 2—cooker cover; 21—cooker cover body; 21—fixing pin; 22—sealing ring; 23—buckle groove; 24—reflex inner housing; 241—inner cover shaft sleeve; 3—heat preservation housing; 31—first through hole; 4—inner pot; 41—pot rim; 5—frying basket; 51—basket body; 52—enclosure ring; 53—tray; 531—ventilation hole; 54—oil baffle; 55—anti-fume sieve; 511—second through hole; 512—third through hole; 6—reflex housing; 7—drive assembly; 71—first fan; 72—motor; 721—motor bracket; 73—second fan; 8—heating assembly; 81—heat-conducting plate; 811—temperature sensor; 813—heat dissipation groove; 82—first heating; 83—second heater; 9—control pressure assembly; 91—pressure ring; 92—elastic body; 93—displacement sensor; 931—trigger push rod.

### DESCRIPTION OF EMBODIMENTS

The accompanying drawings are only for exemplary description, and shall not be construed as limiting the present invention; for ease of description for the embodiments, some parts in the accompanying drawings may be omitted, scaled up or scaled down, which do not represent the practical dimensions of the product; for a person skilled in the art, it is understandable that some commonly known structures may be omitted in accompanying drawings and that their descriptions may be omitted. The positional relationship described in the accompanying drawings is for illustrative purposes only, and cannot be understood as limiting to the present invention.

The same or similar reference numerals in the drawings of the embodiments of the present invention correspond to the same or similar components; in the description of the present invention, it should be understood that if there are the terms “upper”, “lower”, “left”, “right”, and other terms which indicate the orientation or positional relationship based on the orientation or positional relationship that shown in the drawings, they are only for the convenience of describing the present invention and simplifying the description, rather than indicating or implying that the device or element referred to must have a specific orientation and must be constructed and operated in a specific position, so the terms describing the positional relationship in the drawings are only used for exemplary description, and cannot be understood as a limitation of the present patent. For those of ordinary skill in the art, the specific meaning of the above terms can be understood according to the specific situation.

The technical solution of the present invention is further described in detail by specific embodiments and in conjunction with accompanying drawing below.

### Embodiment 1

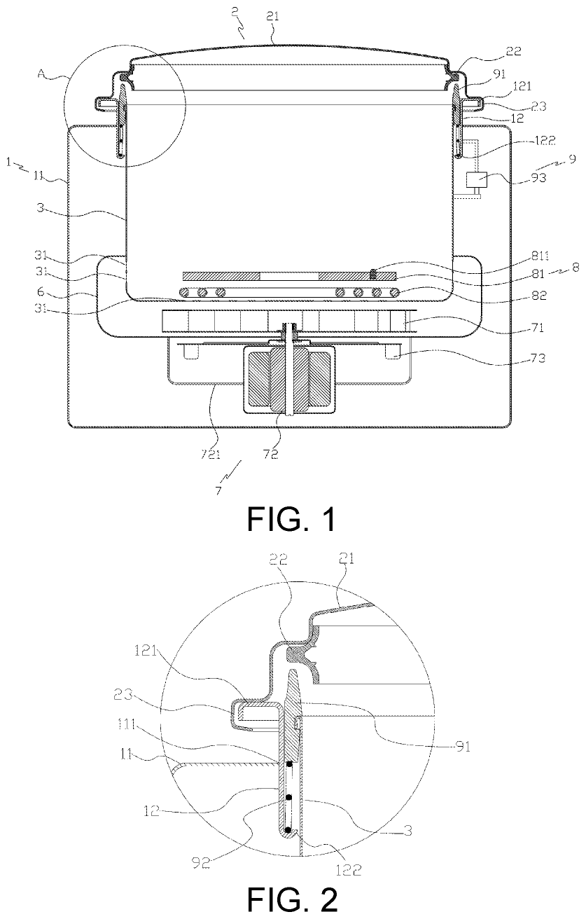

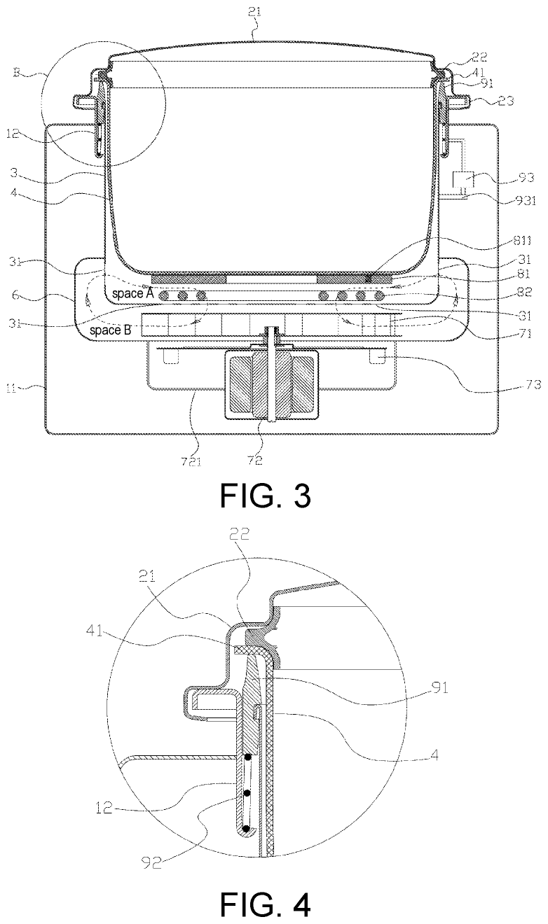

In FIG. 1-FIG. 5, an electric pressure cooker with both pressure cooking and air frying cooking in embodiment 1 is shown, comprising a cooker body 1 and a cooker cover 2, a heat preservation housing 3, a storage assembly, a reflex housing 6, and a drive assembly 7, a heating assembly 8 and the pressure control assembly 9. The storage assembly comprises the inner pot 4 and the frying basket 5. The cooker body 1 comprises a shell body 11 and a cylindrical body 12, wherein a top of the shell body 11 is provided with an opening 111, and the cylindrical body 12 is open at both ends. The cylindrical body 12 is fixedly connected onto the opening 111. An upper edge of the cylindrical body 12 is provided with a number of buckle teeth 121 protruding outwards, and a lower edge of the cylindrical body 12 is bent inward to form a step 122.

The cooker cover 2 can be covered on and engaged with the cooker body 1. The cooker cover 2 comprises a cooker cover body 21, a sealing ring 22 and a buckle groove 23. The buckle groove 23 is formed by a bent inward lower edge of the cooker cover body 21. A sealing ring 22 is provided on an inner side of the cooker cover body 21. The sealing ring 22 is selected according to the size of the inner pot 4, and a sealing ring of a universal pressure cooker can be selected. When the cooker cover 2 is covered on and engaged with the cooker body 1, the buckle groove 23 on the cooker cover 2 and the buckle teeth 121 on the cooker body 1 can be rotated and interlocked with each other, so that the cooker cover 2 can be tightly covered on and engaged with the cooker body 1.

The heat preservation housing 3 is located in the cooker body 1, and the heat preservation housing 3 is a cylindrical structure with an open upper end. A reflex housing 6 is disposed at a lower portion of the heat preservation housing 3, and the reflex housing 6 is communicated with the heat preservation housing 3. Specifically, a bottom portion and a side portion of the heat preservation housing 3 are provided with a plurality of first through holes 31, and the heat preservation housing 3 is communicated with the reflex housing 6 via the first through holes 31.

The reflex housing 6 is connected to the drive assembly 7, and the drive assembly 7 can make the hot air in the heat preservation housing 3 circularly flow in the heat preservation housing 3 and the reflex housing 6, so as to improve the cooking effect of the food.

Specifically, the drive assembly 7 comprises a first fan 71 and a motor 72, wherein the first fan 71 is an axial flow fan, and the first fan 71 is provided on an inner bottom of the reflex housing 6, and wherein the motor 72 is a universal motor, and the motor 72 is located between an inside of the shell 11 and an outer bottom of the reflex housing 6. In present embodiment, a motor bracket 721 of the motor 72 is fixedly provided on the outer bottom of the reflex housing 6, and an output shaft of the motor 72 passes through the bottom of the reflex housing 6 and is connected to the first fan 71. The bottom of the reflex housing 6 is provided with an opening hole through which the output shaft of the motor 72 passes, and the bottom of the reflex housing 6 is fixedly connected to the output shaft of the motor 72 through a sealing bearing.

After the motor 72 is activated, the first fan 71 can be driven by the motor 72 to rotate, and the rotation of the first fan 71 can make the hot air located in the heat preservation housing 3 enter into the reflex housing 6 through the first through holes 31 at the bottom of the heat preservation housing 3, and the hot air in the reflex housing 6 then return to the heat preservation housing 3 through the first through holes 31 on the side portion of the heat preservation housing 3, so that the hot air forms a circulating flow between the heat preservation housing 3 and the reflex housing 6. The air is heated repeatedly in the process of circular flowing, and thus the hot air heats the inner pot 4 which in turn can heat the food in the inner pot 4.

In the present embodiment, the output shaft of the motor 72 is further provided with a second fan 73. The second fan 73 is a cooling fan and may play a role in heat dissipation. The second fan 10 is located below the outer bottom of the reflex housing 6.

The heat preservation housing 3 is connected with a pressure control assembly 9. When the present invention is used as a pressure cooker, that is, when the inner pot 4 is placed in the cooker body 1, the pressure control assembly 9 is used for controlling the pressure in the inner pot 4 to ensure the pressure in the inner pot 4 to be always within a preset range.

Specifically, the pressure control assembly 9 comprises a pressure ring 91, a plurality of elastic bodies 92, a displacement sensor 93 and a controller. The pressure ring 91 is fixedly connected to an upper edge of the heat preservation housing 3, and the plurality of elastic bodies 92 are provided between the pressure ring 91 and the step 122 on the lower edge of the cylindrical body 12.

The displacement sensor 93 is used for detecting the displacement change of the heat preservation housing 3. Preferably, a displacement detection switch is selected as the displacement sensor 93. In the present embodiment, the displacement sensor 93 is fixedly mounted on an outer wall of the cylindrical body 12. A trigger push rod 931 of the displacement sensor 93 is connected to the heat preservation housing 3, and the displacement of the heat preservation housing 3 may trigger connection or disconnection of a contact of the displacement sensor 93. As another embodiment, since the heat preservation housing 3 is fixedly connected to the pressure ring 91, the trigger push rod 931 of the first sensor 93 is also connected to the pressure ring 91.

The controller is mounted in the shell body 11, or mounted at other suitable positions according to actual needs. The controller is not drawn in the drawings. A universal single-chip microcomputer or micro-control processor is selected as the controller. A signal input end of the controller is communicatively connected to the displacement sensor 93, and a signal output end of the controller is communicatively connected to the heating assembly 8. When the contact of the displacement sensor 93 is disconnected, the displacement sensor 93 sends the signal to the controller. After the controller processes the signal, the processed signal is sent to the heating assembly 8 to control the heating assembly 8 to interrupt or reduce heat generation. When the contact of the displacement sensor 93 is connected, the displacement sensor 93 sends the signal to the controller. After the controller processes the signal, the processed signal is sent to the heating assembly 8, and the heating assembly 8 is controlled to activate heating.

An inner bottom of the heat preservation housing 3 is provided with a heating assembly 8, and the heating assembly 8 provides a heat source for cooking food. Specifically, in the present embodiment, the heating assembly 8 comprises a heat-conducting plate 81 and a first heater 82, wherein the heat-conducting plate 81 and the first heaters 82 are both mounted on the inner bottom of the heat preservation housing 3. Specifically, the heat-conducting plate 81 is fixedly mounted on the inner bottom of the heat preservation housing 3 and used for supporting and placing the inner pot 4 or the frying basket 5. The first heater 82 is mounted in the heat preservation housing 3 and located below the heat-conducting plate 81. In the present embodiment, a universal heater is selected as the first heater 82, and the first heater 82 is communicatively connected to the signal output end of the controller.

As a preferred technical solution, a temperature sensor 811 is mounted on the heat-conducting plate 81, and the temperature sensor 811 is used for sensing the temperature of the bottom of the inner pot 4 in the pressure cooking mode. Specifically, the temperature sensor 811 is communicatively connected to the signal input end of the controller. After the temperature sensor 811 transmits the temperature signal to the controller, the controller processes the received signal and then controls the heating condition of the first heater 82.

When the present invention is used as a pressure cooker, the inner pot 4 is placed in the cooker body 1, and an upper edge of the inner pot 4 is provided with an outwardly extending pot rim 41. When the inner pot 4 is placed in the heat preservation housing 3 and the cooker cover 2 is covered on and engaged with the cooker body, a lower surface abuts of the pot rim 41 against the pressure ring 91, and an upper surface of the pot rim 41 abuts against the sealing ring 22. The bottom of the inner pot 4 is located on the heat-conducting plate 81 of the heating assembly 8. During the cooking process, food and water is put in the inner pot 4. In some scenarios, a certain amount of water may be put in the inner pot 4 first, then the frying basket 5 is put in the pot 4, and the food is placed in the frying basket 5.

When the present invention is used as an air fryer, the inner pot 4 needs to be removed from the cooker body 1, and then the frying basket 5 is placed in the cooker body 1. Specifically, the frying basket 5 comprises a basket body 51, an enclosure ring 52, a tray 53, an oil baffle 54 and an anti-fume sieve 55, wherein the enclosure ring 52 is cylindrical, and the enclosure ring 52 is connected to the bottom of the basket body 51. When the frying basket 5 is placed in the cooker body 1, a lower edge of the enclosure ring 52 abuts against the bottom of the heat preservation housing 3.

A side wall of the basket body 51 is provided with a plurality of second through holes 511. A middle position of the bottom of the basket body 51 protrudes inward and the protruding position is provided with a third through hole 512. The oil baffle 54 is provided in the basket body 51 and is located above the third through hole 512, and the oil baffle 54 is provided to prevent oil and water generated during a food cooking process from dripping onto the heating assembly 8 from the third through hole 512.

The tray 53 is detachably abutted in the basket body 51 for placing food, and a plurality of ventilation holes 531 are evenly distributed on the tray 53. The anti-fume sieve 55 is mounted in the basket body 51 and is located between the oil baffle 54 and the third through hole 512. In the present embodiment, the anti-fume sieve 55 can filter the oil fume entering into the heat preservation housing 3 from the basket body 5, thereby ensuring the clean cooking environment.

The heating method of the above-mentioned electric pressure cooker specifically comprises:

When the device needs to be used as a pressure cooker, the inner pot 4 is placed in the heat preservation housing 3 of the cooker body 1, as shown in FIG. 3. At this time, two relatively sealed spaces, i.e., a space A formed between the heat preservation housing 3 and inner pot 4 and a space B formed between the heat preservation housing 3 and the reflex housing 6, are formed at the bottom of the inner pot 4. The first heater 82 is located in the space A, and the first fan 71 is located in the space B. The first heater 82 is activated to generate heat to heat the air in the space A, and at the same time the heat-conducting plate 81 can conduct the heat to the bottom of the inner pot 4. The motor 72 works to drive the first fan 71 to rotate, and the hot air in the space A enters into the space B through the first through hole 31 at the bottom portion of the heat preservation housing 3. The air in the space B enters into the space A through the first through hole 31 on the side portion of the heat preservation housing 3, so the hot air forms a circulating flow between the space A and the space B, so that the air is heated repeatedly during the process of circular flowing. At the same time, the heat-conducting plate 81 is also heated, and then the heat-conducting plate 81 heats the inner pot 4, thereby heating the food or water in the inner pot 4.

After the cooker cover 2 is covered on and engaged with the body 1, the cooker cover 2 and the inner pot 4 form a sealed space. When the water in the inner pot 4 is heated, an internal pressure increases, and a downward pressure is formed in the inner pot 4. The pressure is transmitted to the pressure ring 91 through the pot rim 41, and the pressure ring 91 compresses the elastic bodies 92 downward, resulting in a downward displacement. As the pressure ring 91, the heat preservation housing 3 and the reflex housing 6 is fixedly connected together, the heat preservation housing 3 and the reflex housing 6 will be driven to moves downward when the pressure ring 91 moves downward. The trigger push rod 931 of the displacement sensor 93 will be driven to move downward synchronously when the heat preservation housing 3 moves downward. When the pressure in the inner pot 4 increases to a preset intensity value, the trigger push rod 931 reaches a preset first trigger position, and the displacement sensor 93 will send a disconnection signal, and the controller sends an instruction to reduce output power of the first heater 82 or disconnect the first heater 82, thereby preventing the pressure in the inner pot 4 from rising continuously.

On the contrary, when the pressure in the inner pot 4 is reduced, the pressure on the pressure ring 91 will be reduced, and the elastic body 92 will start to rebound, and a displacement for upward recover of the pressure ring 91 will be generated. When the pressure in the inner pot 4 drops to a preset value, the trigger push rod 931 reaches a preset second trigger position, the displacement sensor 93 will send an connection signal, and the controller controls the first heater 82 to increase the output power. Through such a design, the pressure in the inner pot 4 can always be kept within a design range, so as to ensure the safety of use.

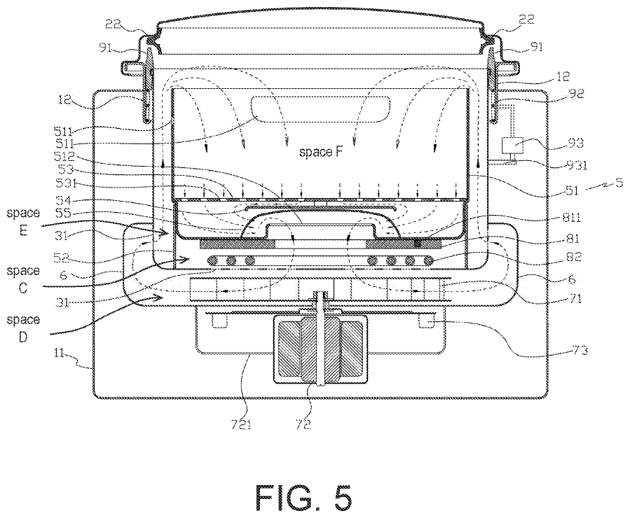

When the device needs to be used as an air fryer, the inner pot 4 needs to be removed from the device, and then the frying basket 5 is placed in the heat preservation housing 3 of the cooker body 1. The food ingredients are placed on the tray 53 in the frying basket, and the enclosure ring 52 abuts against the bottom of the heat preservation housing 3. As shown in FIG. 5, when the cooker cover 2 is covered on and engaged with the cooker body, four relatively independent but interconnected spaces which are space C, space D, space E and space F will be formed in the scope consist of preservation housing 3, the frying basket 5, the reflex housing 6 and the cooker cover 2. Specifically, the space C is formed between the bottom of the basket 51 and the bottom of the heat preservation housing 3, and the space D is formed between the heat preservation housing 3 and the reflex housing 6, the space E is formed between the side wall of the heat preservation housing 3 and the outer side wall of the frying basket 5, and a space F is formed in the basket 51.

The first heater 82 is located in the space C, which can heat the air in the space C. The first fan 71 is located in the space D. When the device is working, the first heater 82 generates heat and heats the air in the space C. The motor 72 drives the fan 71 to rotates so as to drive the hot air in the drive space C to enter into the space D through the first through hole 31 at the bottom of the heat preservation housing 3, and the hot air in the space D enters into the space E through the first through hole 31 on the side portion of the heat preservation housing 3, and the hot air in the space E enters into the interior of the basket body 51, i.e., the space F, through the second through hole 511 on the side wall of the basket body 51 and the opening at the top of the basket body 51. The hot air in the space F then passes through the ventilation holes 531 on the tray 53, and the anti-fume sieve 55 and the third through hole 512 at the bottom of the frying basket 5 and enters into the space C, that is, the circulating flow of the hot air between the space C, the space D, the space E and the space F is realized. The hot air is heated repeatedly in the process of of circular flowing, and simultaneously heats the food ingredients.

Compared with the existing product integrating electric pressure cooker and air fryer, the present invention has both the cooking function of the pressure cooker and the cooking function of the air fryer, and only one cooker cover and one set of heating assembly are provided in the present invention. Only the inner pot or frying basket needs to be replaced when different cooking modes need to be switched. The electric pressure cooker of the present invention convenient and handy, has a low production cost, also very convenient for using. At the same time, in the process of cooking food, the hot air circularly flows, and thus the electric pressure cooker of the present invention can effectively heat and cook the food, and can meet the requirements of product standards, regardless of the cooking performance of the pressure cooker and the air frying performance.

### Embodiment 2

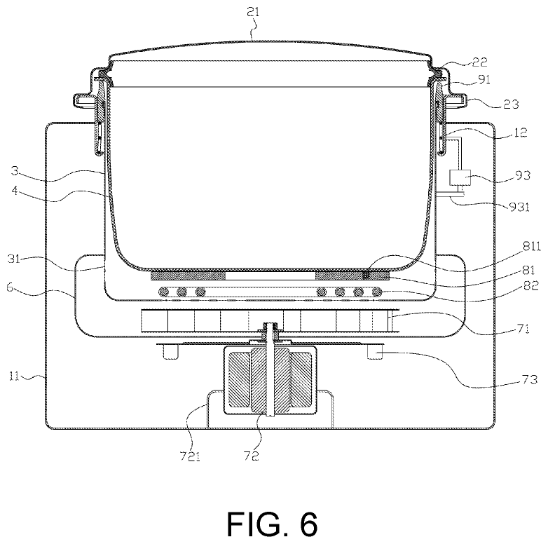

In FIG. 6, an electric pressure cooker with both pressure cooking and air-frying cooking in Embodiment 2 is shown. The difference between the present embodiment and Embodiment 1 is that the motor 72 is fixed on the inner bottom in the housing 11 through the motor bracket 721. Since the heat preservation housing 3 are fixedly connected to the reflex housing 6, when the present invention is used as a pressure cooker, the heat preservation housing 3 will be subjected to the pressure inside the inner pot 4 and results in a displacement. So the reflex housing 6 will also move with the heat preservation housing 3. Therefore, the reflex housing 6 is movably connected to the output shaft of the motor 72, that is, the reflex housing 6 can move up and down along the output shaft of the motor 72. With such arrangement, the motor 72 can be supported more firmly, and the noise generated when the device is working can be reduced.

### Embodiment 3

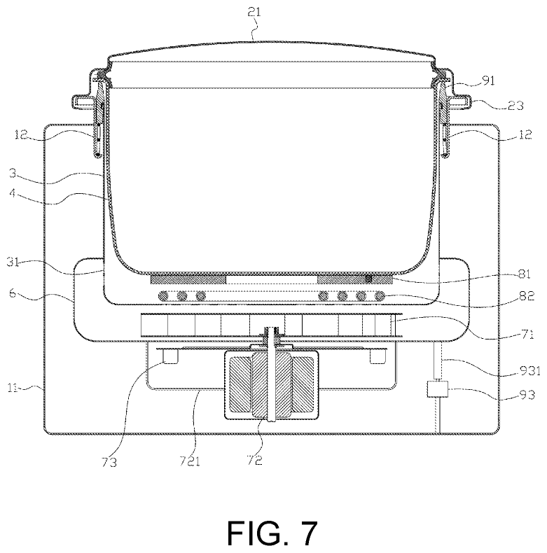

In FIG. 7, an electric pressure cooker with both pressure cooking and air-frying cooking in Embodiment 3 is shown. The difference between the present embodiment and Embodiment 1 is that the displacement sensor 93 is fixedly mounted on the inner side of the bottom of the shell body 11. The trigger push rod 931 of the displacement sensor 93 is connected to the reflex housing 6. The displacement sensor 93 detects the displacement condition of the reflex housing 6, and then transmits the signal to the controller. After the controller processes the signal, it sends the processed signal to the first heater 82 to control the heating condition of the first heater 82.

### Embodiment 4

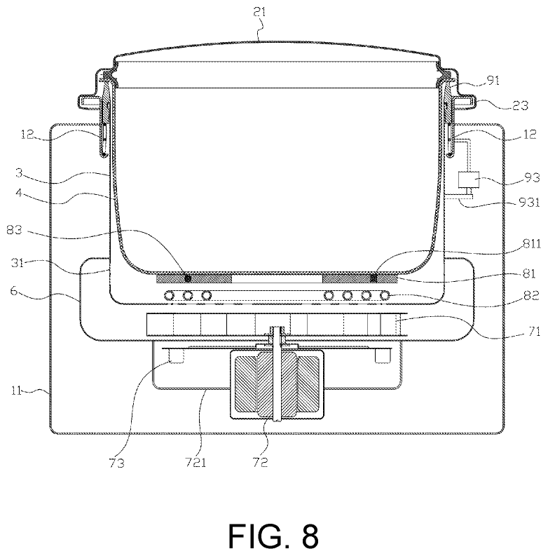

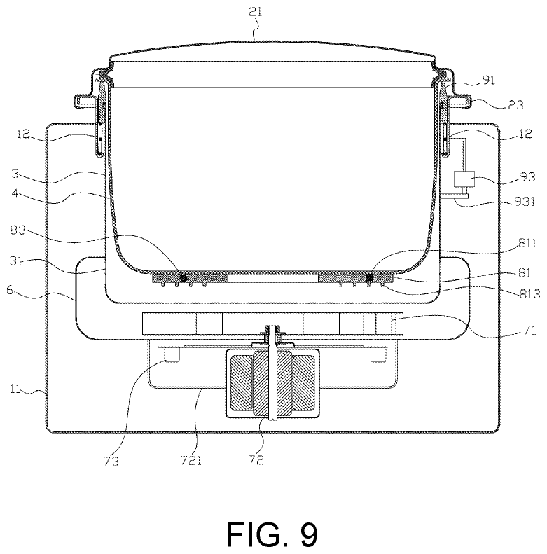

In FIG. 8, an electric pressure cooker with both pressure cooking and air-frying cooking in Embodiment 4 is shown. The difference between the present embodiment and Embodiment 1 is: a second heater 83 is additionally provided in the heat-conducting plate 81 in the present embodiment. The second heater 83 is universal built-in heater. The addition of the second heater 83 enables that the temperature of the heat-conducting plate 81 is raised quickly after the second heater 83 is activated, when the present invention is used as a pressure cooker. Thus, the temperature inside the inner pot 4 may be raised quickly.

### Embodiment 5

As shown in FIG. 9, an electric pressure cooker with both pressure cooking and air-frying cooking in Embodiment 5 is shown. The difference between the present embodiment and Embodiment 1 is that in the present embodiment, the heating assembly 8 only comprises the heat-conducting plate 81 and the second heater 83. And the heat-conducting plate 81 is fixedly mounted on the inner bottom of the heat preservation housing 3 for supporting and placing the inner pot 4 or the frying basket 5. The second heater 83 is provided on the heat-conducting plate 81. A universal built-in heater is selected as the heater 83, and the second heater 83 is communicatively connected with the signal output end of the controller.

As a preferred technical solution, a temperature sensor 811 is mounted on the heat-conducting plate 81, and the temperature sensor 811 is used for detecting the temperature of the heat-conducting plate 81. Specifically, the temperature sensor 811 is communicatively connected the signal input end of the controller. After the temperature sensor 811 transmits the temperature signal to the controller, the controller processes the received signal and then controls the heating condition of the second heater 83.

That the second heater 83 is directly provided on the heat-conducting plate 81 can greatly simplify the arrangement of the heating assembly 8, making the overall structural arrangement simpler and more reliable, and at the same time lowering the cost. As a preferred solution, the bottom of the heat-conducting plate 81 is provided with a plurality of heat dissipation grooves 813, and the arrangement of the heat dissipation grooves 813 enables the heat generated by the second heater 83 to enter into the circulating air more quickly.

### Embodiment 6

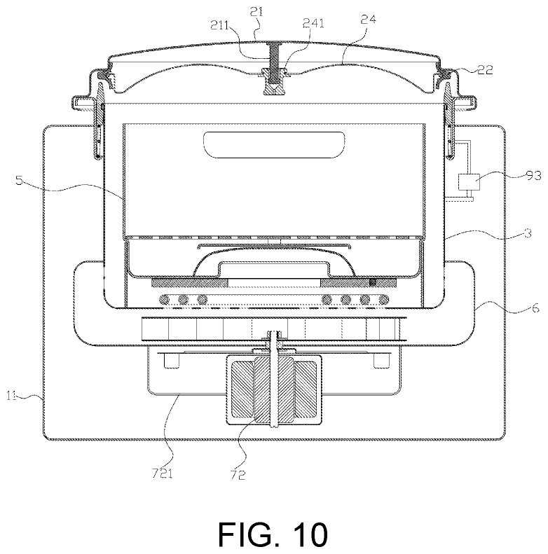

In FIG. 10, an electric pressure cooker with both pressure cooking and air frying cooking in Embodiment 6 is shown. The difference between the present embodiment and Embodiment 1 is that in the present embodiment, the inner side of the cooker cover 2 is further provided with a reflective inner cover 24 and the cooker cover body 21 are fixedly connected to fixing pins 211, and the reflective inner cover 24 is sleeved on the fixing pins 211 through an inner cover shaft sleeve 241. When the present invention is used as an air fryer, the reflective inner cover can block the hot air inside from directly heat the cover body 21 so as to prevent the cover body 21 from malfunction caused by overheating.

Obviously, the above-mentioned embodiments of the present invention are merely examples for clearly illustrating the present invention, rather than limiting the embodiments of the present invention. For those skilled in the art, other different forms of changes or variations can be made based on the above description. There is no need and by no means to exhaustively list all implementations. Any modification, equivalent replacement and improvement made within the spirit and principle of the present invention should be included within the protection scope of the claims of the present invention.

1. An electric pressure cooker with both pressure cooking and air frying cooking, comprising a cooker body and a cooker cover that is capable of being covered on and engaged with the cooker body, wherein the electric pressure cooker with both pressure cooking and air frying cooking further comprises a heat preservation housing provided in the cooker body, an inner pot that is capable of being placed in the heat preservation housing and used for pressure cooking or a frying basket that is capable of being placed in the heat preservation housing and used for air frying cooking, a reflex housing disposed outside the heat preservation housing and a heating assembly provided in the heat preservation housing; the reflex housing is communicated with the heat preservation housing; a drive assembly is further provided in the cooker body, and the drive assembly is capable of making a hot air circularly flow in the heat preservation housing and the reflex housing.

2. The electric pressure cooker with both pressure cooking and air frying cooking according to claim 1, wherein the heat preservation housing is communicated with the reflex housing via a plurality of first through holes; the plurality of first through holes are respectively provided at a bottom portion and a side portion of the heat preservation housing.

3. The electric pressure cooker with both pressure cooking and air frying cooking according to claim 1, wherein characterize din that the frying basket comprises a basket body, an enclosure ring for supporting the basket body, and a tray with ventilation holes which is provided in the basket body; a side wall of the basket body is provided with a plurality of second through holes; a bottom portion of the basket body is provided with a third through hole; the basket body is provided with an oil baffle for blocking oil and water generated during a food cooking process; the oil baffle is located above the third through hole; an anti-fume sieve for filtering an oil fume entering the heat preservation housing from the basket body is further provided in the basket body, and the anti-fume sieve is located between the oil baffle and the third through hole.

4. The electric pressure cooker with both pressure cooking and air frying cooking according to claim 1, wherein the heat preservation housing is connected with a pressure control assembly for controlling a pressure in the inner pot during a cooking process.

5. The electric pressure cooker with both pressure cooking and air frying cooking according to claim 4, wherein the pressure control assembly comprises a pressure ring, a plurality of elastic bodies, a displacement sensor for detecting a position change of the heat preservation housing and a controller; the pressure ring is fixedly connected to the heat preservation housing; one end of the plurality of elastic bodies is connected to the pressure ring, and another end of the plurality of elastic bodies is connected to the cooker body; a signal input end of the controller is communicatively connected to the displacement sensor, and a signal output end of the controller is communicatively connected to the heating assembly.

6. The electric pressure cooker with both pressure cooking and air frying cooking according to claim 5, wherein the displacement sensor is fixedly provided on the cooker body; the displacement sensor is a displacement detection switch; a trigger push rod of the displacement detection switch is connected to the heat preservation housing, or is connected to the pressure ring, or is connected to the reflex housing when the reflex housing is fixedly connected to the heat preservation housing.

7. The electric pressure cooker with both pressure cooking and air frying cooking according to claim 5, wherein the cooker cover comprises a cooker cover body and a sealing ring; the sealing ring is provided on an inner side of the cooker cover body; an upper edge of the inner pot is provided with an outwardly extending pot rim; when the inner pot is placed in the heat preservation housing and when the cooker cover is covered on and engaged with the cooker body, an upper surface of the pot rim abuts against the sealing ring, and a lower surface of the pot rim abuts against the pressure ring.

8. The electric pressure cooker with both pressure cooking and air frying cooking according to claim 5, wherein the cooker body comprises a shell body and a cylindrical body that is capable of being interlocked with the cooker cover, the cylindrical body is connected to the shell body; a lower edge of the cylindrical body is bent inward to form a step; the plurality of elastic bodies is provided between the pressure ring and the step.

9. The electric pressure cooker with both pressure cooking and air frying cooking according to claim 7, wherein the cooker cover further comprises a reflective inner cover; the reflective inner cover is provided on the inner side of the cooker cover body.

10. The electric pressure cooker with both pressure cooking and air frying cooking according to claim 1, wherein the drive assembly comprises a first fan that is rotatable and a motor for driving a movement of the first fan; an output shaft of the motor is connected to the first fan; the first fan is provided in the reflex housing; the motor is provided at an outer side of the reflex housing; the motor is connected to the cooker body or connected to the reflex housing via a motor bracket.

11. The electric pressure cooker with both pressure cooking and air frying cooking according to claim 1, wherein the heating assembly comprises a heat-conducting plate for supporting the inner pot or the frying basket and a first heater located below the heat-conducting plate; the heat-conducting plate and the first heater are both provided in the heat preservation housing.

12. The electric pressure cooker with both pressure cooking and air frying cooking according to claim 1, wherein the heating assembly comprises a heat-conducting plate for supporting the inner pot or the frying basket and a second heater provided on the heat-conducting plate; the heat-conducting plate is provided in the heat preservation housing; the heat-conducting plate are provided with several heat dissipation grooves.

13. The electric pressure cooker with both pressure cooking and air frying cooking according to claim 1, wherein heating assembly comprises a heat-conducting plate for supporting the inner pot or the frying basket and a first heater located below the heat-conducting plate; the heat-conducting plate and the first heater are both provided in the heat preservation housing, the heating assembly further comprises a second heater provided on the heat-conducting plate.

14. The electric pressure cooker with both pressure cooking and air frying cooking according to claim 11, wherein a temperature sensor for detecting a temperature of the heat-conducting plate is provided in the heat-conducting plate.

15. A heating method of the electric pressure cooker with both pressure cooking and air frying cooking according to claim 1, wherein comprises:
when an inner pot is placed in a heat preservation housing and used as a pressure cooker, forming a space A by a space between the inner pot and the heat preservation housing, and forming a space B by a space between the heat preservation housing and a reflex housing, and a heating assembly located in the heat preservation housing being capable of simultaneously heating air in the space A and an bottom of the inner pot, and under an driving action of a drive assembly, air heating in the space A forming a circulating flow between the space A and the space B to heat food in the inner pot;
when the inner pot is removed and a frying basket is placed in the heat preservation housing and used as an air fryer, forming a space C between the frying basket and an bottom of the heat preservation housing, forming a space D between the heat preservation housing and the reflex housing, forming a space E by the frying basket and a side wall of the heat preservation housing, and forming a space F by a space in the frying basket, the heat preservation housing being capable of heating air in the space C first, under the driving action of the drive assembly, air heating in the space C being capable of passing through the space D, the space E and the space F in sequence, and then flowing into the space C to form a circulating flow to heat food in the frying basket.

16. The electric pressure cooker with both pressure cooking and air frying cooking according to claim 12, wherein a temperature sensor for detecting a temperature of the heat-conducting plate is provided in the heat-conducting plate.

17. The electric pressure cooker with both pressure cooking and air frying cooking according to claim 13, wherein a temperature sensor for detecting a temperature of the heat-conducting plate is provided in the heat-conducting plate.
